(19) United States
(12) Patent Application Publication
(10) Pub. No.: US 2023/0219371 A1
(43) Pub. Date: Jul. 13, 2023

(54) PNEUMATIC TIRE

(71) Applicant: The Yokohama Rubber Co., LTD., Tokyo (JP)

(72) Inventors: Tomoyuki WADA, Kanagawa (JP); Takamitsu CHAYA, Kanagawa (JP)

(21) Appl. No.: 18/002,211

(22) PCT Filed: Jun. 22, 2021
(86) PCT No.: PCT/JP2021/023570

§ 371 Date: Dec. 16, 2022

(30) Foreign Application Priority Data
Jun. 23, 2020 (JP) 2020-107815

(51) Int. Cl. B60C 1/00; C08K 3/04; C08L 7/00; C08L 91/00; B60C 9/22

(52) U.S. Cl. CPC B60C 1/0016; B60C 1/0025; B60C 1/0041; C08K 3/04; C08L 7/00; C08L 91/00; B60C 9/22; B60C 2001/005; C08K 2201/006; B60C 2009/2238

(57) ABSTRACT

In a pneumatic tire in which a reinforcing layer including a cord is embedded, a coating rubber covering the cord included in the reinforcing layer uses a rubber composition in which 30 parts by mass to 60 parts by mass of carbon black having a nitrogen adsorption specific surface area N₂SA of 100 m²/g or more and 0 parts by mass or more and 10 parts by mass or less of aroma oil is optionally blended, per 100 parts by mass of a rubber component containing 70 mass % to 100 mass % of a natural rubber and in which a strength at break TB (unit: MPa) at 100° C. and a stress M100 (unit: MPa) at 100% elongation at 100° C. satisfy a relationship TB²/M100≥50.0.

### TECHNICAL FIELD

The present technology relates to a pneumatic tire including a reinforcing layer including a cord.

### BACKGROUND ART

In recent years, performance required for tires has been increasing, and for example, providing not only steering stability during high-speed travel and low rolling resistance performance but also high-speed durability in a highly compatible manner is awaited. Thus, it has been studied to achieve a high degree of hardness and low heat build-up of rubber (rubber composition) that constitutes each portion of the tire and to provide the various tire performances described above in a compatible manner.

In the related arts, portions (such as tread portion, sidewall portion, bead portion) where a large amount of rubber is used have been considered as portions to achieve such a high degree of hardness and low heat build-up. To improve a tire performance further, it has also been considered to achieve the high degree of hardness and the low heat build-up described above for a coating rubber that covers a cord in portions where a small amount of rubber is used, for example, reinforcing layers including a cord (such as a carcass layer, a belt layer, and a belt reinforcing layer) (see, for example, Japan Unexamined Patent Publication No. 2017-031381). Such a coating rubber requires not only the high degree of hardness and low heat build-up but also excellent adhesiveness to the cord, and thus leaving room for further improvement. Then, providing these performances in a well-balanced and compatible manner and exhibiting excellent high-speed steering stability, low rolling resistance, and high-speed durability are also awaited.

### SUMMARY

The present technology provides a pneumatic tire that can provide the high-speed steering stability, high-speed durability, and low rolling resistance in a highly compatible manner.

A pneumatic tire according to an embodiment of the present technology includes a tread portion extending in a tire circumferential direction and having an annular shape, a pair of sidewall portions respectively disposed on both sides of the tread portion, a pair of bead portions each disposed on an inner side of the pair of sidewall portions in a tire radial direction, and a reinforcing layer containing a cord embedded in at least one portion selected from the tread portion, the sidewall portions, and the bead portions. In the pneumatic tire, a coating rubber covering the cord included in the reinforcing layer is made of a rubber composition in which 30 parts by mass to 60 parts by mass of carbon black having a nitrogen adsorption specific surface area N₂SA of 100 m²/g or more is blended and 0 parts by mass or more and 10 parts by mass or less of aroma oil is optionally blended, per 100 parts by mass of a rubber component containing 70 mass % to 100 mass % of a natural rubber and in which a strength at break TB (unit: MPa) at 100° C. and a stress M100 (unit: MPa) at 100% elongation at 100° C. satisfy a relationship TB²/M100≥50.0.

In an embodiment of the present technology, the coating rubber is made of the rubber composition including the above-described blend, allowing the high-speed steering stability, high-speed durability, and low rolling resistance to be improved. In particular, a large amount of natural rubber in the rubber component is included, an appropriate amount of carbon black having a large nitrogen adsorption specific surface area N₂SA and excellent reinforcing property is blended, and the blended amount of the aroma oil is kept low, allowing these performances to be provided in a highly compatible manner. Furthermore, the rubber composition constituting the coating rubber satisfies the relationship of physical properties described above, and thus excellent high-speed durability can be exhibited. The cooperation can provide the high-speed steering stability, high-speed durability, and low rolling resistance in a highly compatible manner.

Note that, in an embodiment of the present technology, “nitrogen adsorption specific surface area (N₂SA)” is a value measured in accordance with JIS (Japanese Industrial Standard) 6217-2. “Strength at break TB at 100° C.” is a value (unit: MPa) measured under the condition of temperature of 100° C. in accordance with JIS K6251. “Tensile stress M100 at 100% elongation at 100° C.” is a value measured under the condition of a tensile speed of 500 mm/minute and a temperature of 100° C. using a No. 3 dumbbell test piece in accordance with JIS K6251.

In an embodiment of the present technology, the cord is preferably made of an organic fiber. This improves the adhesiveness between the cord and the coating rubber, advantageously improving high-speed durability.

In an embodiment of the present technology, the product A=D×E of the regular fineness D per cord (unit: dtex/cord) and a cord count E per 50 mm (unit: cord count/50 mm) of the cord in a direction orthogonal to an extension direction of the cord preferably ranges from 1.0×10⁵ dtex/50 mm to 3.0×10⁵ dtex/50 mm. Using such a cord expects the effect of improving high-speed steering stability, high-speed durability, and low rolling resistance due to the cord properties, advantageously improving these performances in a well-balanced manner.

In an embodiment of the present technology, the cord preferably has an elongation under a 1.5 cN/dtex load of from 5.0% to 8.0% and an elongation at break of 20% or more. Using such a cord can expect the effect of further improving high-speed steering stability, high-speed durability, and low rolling resistance due to the cord properties, advantageously improving these performances in a well-balanced manner. Note that “the elongation at break” and “the elongation under a load of 1.5 cN/dtex” both refer to an elongation ratio (%) of a sample cord that is measured under the conditions of a distance between grips of 250 mm and a tensile speed of 300±20 mm/min in accordance with JIS L1017 “Test methods for chemical fibre tire cords”. “The elongation at break” is a value measured when a cord is broken, and “the elongation under a load of 1.5 cN/dtex” is a value measured when a load of 1.5 cN/dtex is applied.

In an embodiment of the present technology, the reinforcing layer described above is preferably a carcass layer. Adopting the coating rubber described above in the carcass layer that forms the tire backbone among tire components can exhibit the effect of the coating rubber described above more effectively, advantageously improving high-speed steering stability, high-speed durability, and low rolling resistance in a well-balanced manner.

### BRIEF DESCRIPTION OF DRAWINGS

FIG. 1 is a meridian cross-sectional view illustrating a pneumatic tire according to an embodiment of the present technology.

### DETAILED DESCRIPTION

Configurations of the present technology will be described in detail below with reference to the accompanying drawings.

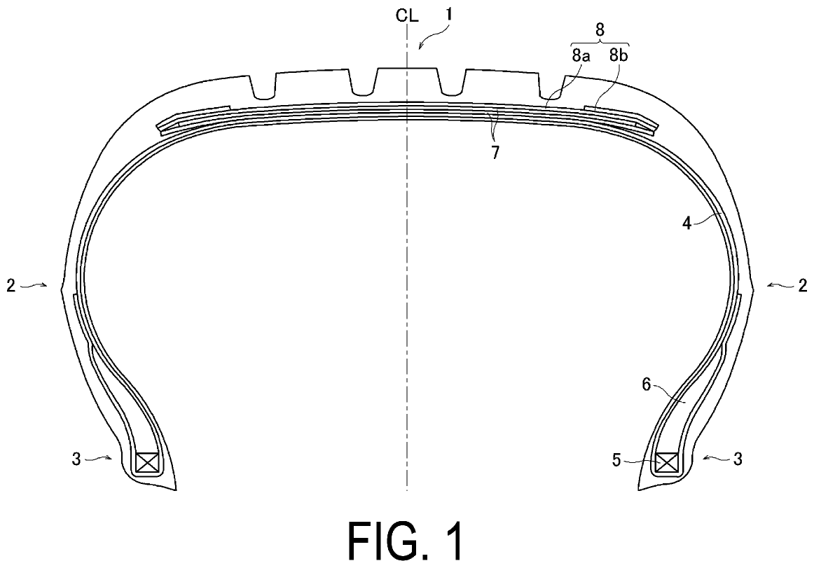

As illustrated in FIG. 1, a pneumatic tire of an embodiment of the present technology includes a tread portion 1, a pair of sidewall portions 2 respectively disposed on both sides of the tread portion 1, and a pair of bead portions 3 each disposed on the inner side of the pair of sidewall portions 2 in the tire radial direction. Note that “CL” in FIG. 1 denotes a tire equator. Although not illustrated in FIG. 1, which is a meridian cross-sectional view, the tread portion 1, the sidewall portions 2, and the bead portions 3 each extend in a tire circumferential direction to form an annular shape. This forms a toroidal basic structure of the pneumatic tire. Although the description using FIG. 1 is basically based on the illustrated meridian cross-sectional shape, all of the tire components each extend in the tire circumferential direction and form the annular shape.

A carcass layer 4 including a plurality of reinforcing cords (hereunder, referred to as carcass cords) extending in the tire radial direction is mounted between the pair of bead portions 3 on the right and left. A bead core 5 is embedded within each of the bead portions, and a bead filler 6 having an approximately triangular cross-sectional shape is disposed on an outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4.

A plurality (in the illustrated example, two layers) of belt layers 7 are embedded on an outer circumferential side of the carcass layer 4 in the tread portion 1. Each of the belt layers 7 includes a plurality of reinforcing cords (hereunder, referred to as belt cords) inclined with respect to the tire circumferential direction, with the belt cords of the layers intersecting each other. In the belt layers 7, an inclination angle of the belt cord with respect to the tire circumferential direction is set within a range of, for example, from 10° to 40°. For example, steel cords are preferably used as the belt cords.

To improve the high-speed durability, a belt reinforcing layer 8 is further provided on an outer circumferential side of the belt layers 7. The belt reinforcing layer 8 includes a reinforcing cord (hereinafter, referred to as cover cord) oriented in the tire circumferential direction. In the belt reinforcing layer 8, the angle of the cover cord with respect to the tire circumferential direction is set to, for example, from 0° to 5°. As the belt reinforcing layer 8, a full cover layer 8a that covers the entire region of the belt layers 7 in the width direction, a pair of edge cover layers 8b that locally cover both end portions of the belt layers 7 in the tire width direction, or a combination thereof can be provided (in the example illustrated, both of the full cover layer 8a and the edge cover layers 8b are provided). The belt reinforcing layer 8 can be formed, for example, by helically winding a strip material made of at least a single cover cord arranged and covered with coating rubber in the tire circumferential direction.

An embodiment of the present technology relates to a rubber that covers a cord (coating rubber) in a reinforcing layer including a cord (a carcass cord, a belt cord, or a cover cord), such as the carcass layer 4, the belt layer 7, or the belt reinforcing layer 8 described above. Thus, the basic structure of the tire is not limited to those described above except for features related to the cord and the coating rubber described below. Note that the following description may collectively refer to a reinforcing layer including a cord as a “cord reinforcing layer”. In the tire described above, the carcass layer 4, the belt layer 7, and the belt reinforcing layer 8 correspond to the cord reinforcing layer, but in the case of a tire that provides a layer corresponding to the cord reinforcing layer other than these layers (other cord reinforcing layer), the configuration described below can also be applied to the other cord reinforcing layer.

An embodiment of the present technology is preferably applied to a layer in which a cord is made of an organic fiber of the cord reinforcing layers. In other words, the cord to which an embodiment of the present technology is applied is preferably an organic fiber cord in which filament bundles of organic fibers are intertwined. That is, the coating rubber described below exhibits particularly excellent adhesiveness to the organic fiber cord, and applying to the cord reinforcing layer made of an organic fiber can effectively improve high-speed durability. In the illustrated example, as described above, the cords of the carcass layer 4 and the belt reinforcing layer 8 are made of the organic fiber, and thus an embodiment of the present technology is preferably applied to these layers. Of these, an embodiment of the present technology can be suitably used for the carcass layer 4.

When the cord is made of an organic fiber, in the cord reinforcing layer, the product A=D×E of the regular fineness D per cord (unit: dtex/cord) and the cord count E per 50 mm (unit: cord count/50 mm) of the cord in a direction orthogonal to the extension direction of the cord preferably ranges from 1.0×10⁵ dtex/50 mm to 3.0×10⁵ dtex/50 mm. In particular, when the cord reinforcing layer is the carcass layer 4, the product A described above is more preferably from 1.8×10₅ dtex/50 mm to 2.7×10₅ dtex/50 mm. In addition, when the cord reinforcing layer is the belt reinforcing layer 8, the product A described above is more preferably from 1.2×10₅ dtex/50 mm to 2.2×10₅ dtex/50 mm. Such a setting can more effectively exhibit the effect of improving high-speed steering stability, high-speed durability, and low rolling resistance due to the cord properties, advantageously improving these performances in a well-balanced manner. When the product A described above is 1.0×10₅ dtex/50 mm or less, the hardness of the cord reinforcing layer cannot be sufficiently obtained, failing to obtain the desired effect. For example, when the cord reinforcing layer is the carcass layer 4, the high-speed steering stability is decreased. When the product A described above exceeds 3.0×10₅ dtex/50 mm, the hardness of the cord reinforcing layer becomes excessive, failing to obtain the desired effect. For example, when the cord reinforcing layer is the carcass layer 4, the high-speed durability is decreased.

When the cord is made of an organic fiber, the elongation at break of the cord is preferably 20% or more, and more preferably from 24% to 28%. Setting the range of the elongation at break in this way can provide the high-speed steering stability and high-speed durability in a compatible manner. In particular, when the cord reinforcing layer is the carcass layer 4, shock burst resistance can be improved. That is, the shock burst resistance can be determined by, for example, a plunger energy test (a test to measure a failure energy at the time of tire breakage by pushing a plunger having a predetermined size against the central portion of the tread), using the cord having the above-described elongation at break allows deformation during the test (when pressed by the plunger), and thus favorable results can be obtained in the plunger energy test. In other words, applied to during tire travel, the failure durability (corresponding to the failure energy described above) of the tread portion 1 against a projection input can be improved, and the shock burst resistance of the pneumatic tire can be improved.

When the cord is made of an organic fiber, the elongation under a load of 1.5 cN/dtex of the cord is preferably from 5.0% to 8.0%, and more preferably from 6.0% to 7.0%. Setting the physical properties of the cord in this way moderately reduces the rigidity of the cord reinforcing layer in which the cord is used, thus allowing the steering stability to be satisfactory. For example, when the cord reinforcing layer is the carcass layer 4, the rigidity in the tread portion 1 (in particular, a region overlapping the belt layers 7) is moderately low. This can ensure a sufficient ground contact area and enables satisfactory steering stability. When the elongation under the load of 1.5 cN/dtex of the cord is less than 5.0%, the rigidity of the cord reinforcing layer increases, and the desired effect cannot be obtained sufficiently. For example, when the cord reinforcing layer is the carcass layer 4, the compression strain of the tuned up end portions of the carcass layer 4 immediately under a ground contact region is increased, and the cord may be broken (that is, the durability may be impaired). When the elongation under the load of 1.5 cN/dtex of the cord exceeds 8.5%, the rigidity of the cord reinforcing layer cannot be sufficiently ensured, and the desired effect cannot be obtained sufficiently. For example, when the cord reinforcing layer is the carcass layer 4, the effect of ensuring the ground contact area described above cannot be sufficiently obtained, limiting the effect of improving steering stability.

Furthermore, when the cord is made of an organic fiber, a thermal shrinkage rate of the cord preferably ranges from 0.5% to 2.5%, and more preferably from 1.0% to 2.0%. Note that “thermal shrinkage rate” is a dry thermal shrinkage rate (%) of sample cords measured in accordance with JIS L1017 “Test methods for chemical fiber tire cords” with a length of specimen being 500 mm and when heated at 150° C. for 30 minutes. Using cords having such a thermal shrinkage rate can suppress the reduction in the durability or the deterioration in the uniformity due to the occurrence of kinking (twisting, folding, wrinkling, collapsing in shape, and the like) in the organic fiber cords during vulcanization. In this case, when the thermal shrinkage rate of the cord is less than 0.50%, kink tends to occur during vulcanization, making it difficult to satisfactorily maintain durability. When the thermal shrinkage rate of the cord exceeds 2.5%, uniformity may degrade.

In addition, when the cord is made of an organic fiber, a twist coefficient K of the cord represented by Formula (1) described below is preferably from 2000 to 2500, and more preferably from 2100 to 2400. Note that the twist coefficient K is a value of the cord after dip treatment. Using a cord having such a twist coefficient K achieves good cord fatigue and can ensure excellent durability. In this case, when the twist coefficient K of the cord is less than 2000, the cord fatigue deteriorates, making it difficult to ensure durability. When the twist coefficient K of the cord exceeds 2500, productivity of the cord degrades.

K=T×D^{1/2} (1)

(where T is a cable twist count (counts/10 cm) of cord, and D is the total fineness (dtex) of cord)

The type of organic fibers constituting the organic fiber cord described above is not limited. For example, polyester fibers, nylon fibers, or aromatic polyamide fibers (aramid fibers) can be used, and in particular, polyester fibers can be suitably used. Additionally, examples of the polyester fibers include polyethylene terephthalate fibers (PET fibers), polyethylene naphthalate fibers (PEN fibers), polybutylene terephthalate fibers (PBT), and polybutylene naphthalate fibers (PBN), with PET fibers being particularly suitable. Whichever fiber is used, the physical properties of the fiber advantageously provide the high-speed durability and the steering stability in a well-balanced and highly compatible manner. In particular, in the case of PET fibers, since the PET fibers are inexpensive, the cost of the pneumatic tire can be reduced. In addition, workability in producing cords can be increased.

As described above, the cord constituting the cord reinforcing layer is covered by the coating rubber. In an embodiment of the present technology, the rubber component of the rubber composition constituting the coating rubber (hereinafter referred to as the rubber composition according to an embodiment of the present technology) necessarily contains natural rubber. In particular, the natural rubber contains 70 mass % to 100 mass % and preferably contains 75 mass % to 90 mass % in the rubber component. Containing a sufficient amount of natural rubber in this way can obtain the desired rubber physical property. In particular, combining a sufficient amount of natural rubber and specific carbon black described below can improve the peel resistance strength between the cord and rubber and tire durability. When the blended amount of the natural rubber is out of the range described above, the desired effect of an embodiment of the present technology cannot be sufficiently obtained.

In the rubber composition according to an embodiment of the present technology, other synthetic rubber than the natural rubber (hereinafter, referred to as other rubber), for example, diene rubber can also be blended as the rubber component. As other rubber, a rubber that is generally used in a rubber composition for a tire such as polybutadiene rubber, isoprene rubber, styrene-butadiene rubber can be used. Of these, styrene-butadiene rubber can be suitably used. The blended amount (mass %) of these other diene rubbers in the rubber component, which is the residual amount of the natural rubber described above, ranges from 30 mass % to 0 mass % preferably from 25 mass % to 10 mass %. The other diene rubber may be used alone or as a freely chosen blend.

In the rubber composition according to an embodiment of the present technology, 30 parts by mass to 60 parts by mass, preferably 35 parts by mass to 55 parts by mass, of carbon black is blended, and per 100 parts by mass of the rubber component described above. The nitrogen adsorption specific surface area N₂SA of the carbon black used in an embodiment of the present technology is 100 m²/g or more, and more preferably from 100 m²/g to 130 m²/g. Appropriately blending carbon black having a large nitrogen adsorption specific surface area N₂SA and excellent reinforcing property in this way can improve hardness and wear resistance. When the blended amount of carbon black is less than 30 parts by mass, the mechanical properties of the rubber composition cannot be sufficiently ensured, and the basic tire performance (for example, hardness and wear resistance) may be decreased. When the blended amount of carbon black exceeds 60 parts by mass, heat build-up degrades and it is difficult to sufficiently ensure the low rolling resistance. When the nitrogen adsorption specific surface area N₂SA is less than 100 m²/g, the reinforcing effect of the carbon black cannot be sufficiently obtained, and it is difficult to ensure the desired tire performance.

The rubber composition according to an embodiment of the present technology may also include other inorganic fillers than the carbon black. Examples of other inorganic fillers include silica, clay, talc, calcium carbonate, mica, and aluminum hydroxide.

In the rubber composition according to an embodiment of the present technology, aroma oil can be optionally blended. When the aroma oil is blended, the blended amount is 10 parts by mass or less and preferably ranges from 0.0 parts by mass to 5.0 parts by mass, per 100 parts by mass of the rubber component described above. In other words, in the rubber composition according to an embodiment of the present technology, the blended amount of the aroma oil is regulated to 10 parts by mass or less. Reducing the blended amount of the aroma oil or blending no aroma oil can satisfactorily maintain the heat build-up that may degrade when the carbon black having high reinforcing property described above is blended and can improve the balance of the hardness and heat build-up of the rubber. When the blended amount of the aroma oil exceeds 10 parts by mass, it is difficult to provide the hardness and heat build-up of the rubber in a well-balanced and compatible manner.

In the rubber composition according to an embodiment of the present technology, compounding agents other than those above may also be added. Examples of other compounding agents include various compounding agents generally used in rubber compositions for a tire, such as vulcanizations or crosslinking agents, vulcanization accelerators, anti-aging agents, liquid polymers, thermosetting resins, and thermoplastic resins. These compounding agents can be blended in typical amounts conventionally used so long as the present technology is not hindered. Further, as a kneader, a typical rubber kneading machine, such as a Banbury mixer, a kneader, or a roll mill can be used.

The rubber composition according to an embodiment of the present technology with the above-described blend can improve high-speed steering stability, high-speed durability, and low rolling resistance. In particular, as described above, a large amount of natural rubber is included in the rubber component, and an appropriate amount of carbon black having a large nitrogen adsorption specific surface area N₂SA and excellent reinforcing property is blended, and the blended amount of the aroma oil is kept low, allowing these performances to be provided in a highly compatible manner. Therefore, when used in combination with the coating rubber covering the cord described above, these performances can be effectively exhibited.

The rubber composition according to an embodiment of the present technology has the above-described blend, and also a strength at break TB (unit: MPa) at 100° C. and a stress M100 (unit: MPa) at 100% elongation at 100° C. satisfy the relationship TB²/M100≥50.0 and preferably satisfy the relationship 75≤TB²/M100≤125. Since the rubber composition according to an embodiment of the present technology has such physical properties, even more excellent high-speed durability can be exhibited. When TB²/M100 is out of the above-described range, the balance between the strength at break TB and the stress M100 at 100% elongation is poor, and thus the effect of improving high-speed durability is not sufficiently obtained.

In the rubber composition according to an embodiment of the present technology, when TB²/M100 satisfies the above-described range, the range of each of the strength at break TB and the stress M100 at 100% elongation is not particularly limited, but the strength at break TB at 100° C. can be set to, for example, from 13.5 MPa to 17.5 MPa, and the stress M100 at 100% elongation at 100° C. can be set to, for example, from 1.0 MPa to 3.5 MPa. Note that these strength at break TB and the stress M100 at 100% elongation are not only set by the blend described above and are physical properties that can be adjusted also by, for example, kneading conditions and kneading methods.

An embodiment of the present technology will further be described below by way of Examples, but the scope of an embodiment of the present technology is not limited to Examples.

### EXAMPLE

Pneumatic tires according to Comparative Examples 1 to 4 and Examples 1 to 8 having a tire size of 195/65R15 and the basic structure illustrated in FIG. 1 were manufactured. In the pneumatic tires, the blend and physical properties of the coating rubber that covers the cord constituting the carcass layer (TB²/M100 calculated from the strength at break TB at 100° C. and the tensile stress M100 at 100% elongation at 100° C.) were set as in Table 1, and for the cord constituting the carcass layer, the type of organic fiber constituting the cord and the product A (=D×E) calculated from the regular fineness D per cord (unit: dtex/cord) and the cord count E per 50 mm (unit: cord count/50 mm) in a direction orthogonal to the extension direction of the cord were set as in Table 1.

“Strength at break TB at 100° C.” was measured under the condition of temperature of 100° C. in accordance with JIS K6251 in Table 1. “Tensile stress M100 at 100% elongation at 100° C.” was measured at a tensile speed of 500 mm/minute and a temperature of 100° C. using a No. 3 dumbbell test piece in accordance with JIS K6251.

High-speed steering stability, high-speed durability, and low rolling resistance for these test tires were evaluated according to the following evaluation method and the results are also shown in Table 1. Additionally, for the coating rubber, hardness and tan δ at 60° C. (hereinafter, referred to as tan δ (60° C.)) were evaluated according to the following method in the state of the rubber before used in the tire, and the results are also shown in Table 1.

Hardness of Coating Rubber

For the coating rubber used in each test tire, the rubber hardness was measured using a type A durometer at a temperature of 20° C. in accordance with the durometer hardness test specified in JIS K6253. The evaluation results are expressed as index values with measurement values of Comparative Example 1 being assigned the value of 100. Larger index values indicate larger hardness.

Coating Rubber Tan δ (60° C.)

For the coating rubber used for each test tire, tan δ at 60° C. was measured at a temperature of 60° C., a frequency of 20 Hz, an initial distortion of 10%, and a dynamic strain of +2% using a viscoelastic spectrometer available from Toyo Seiki Seisaku-sho, Ltd. The evaluation results are expressed with the values of Comparative Example 1 expressed as an index of 100 using reciprocals of measurement values. Larger index values indicate smaller tan δ (60° C.) and lower heat build-up.

High-Speed Steering Stability

Each of the test tires was assembled on a wheel having a rim size of 15×6J, inflated to an air pressure of 210 kPa, and mounted on a test vehicle having an engine displacement of 1500 cc, and sensory evaluations for high-speed steering stability were performed under the condition of speed 100 km/h on a test course of dry road surfaces by a test driver with two occupants riding in the vehicle. Evaluation results are expressed with the values of Comparative Example 1 expressed as an index of 100. Larger index values indicate superior high-speed steering stability.

High-Speed Durability

Each of the test tires was assembled on a wheel having a rim size of 15×6J, inflated to an air pressure of 260 kPa, and mounted on a drum testing machine (drum diameter 1707 mm), and the ambient temperature was controlled to 38±3° C., the speed was increased from 120 km/h in increments of 10 km/h every 30 minutes, and the travel distance until failure occurred in the tire was measured. The evaluation results are expressed as index values with measurement values of Comparative Example 1 being assigned the value of 100. Larger index values indicate longer travel distance until failure occurs in the tire and better high-speed durability.

Low Rolling Resistance

Each test tire was assembled on a wheel having a rim size of 15×6J and inflated to an air pressure of 210 kPa, then each was mounted on an indoor drum testing machine (drum diameter 1707 mm) conforming to JIS D 4230, and the resistance (rolling resistance) was measured under a test load of 4.82 kN at a speed of 80 km/h. The evaluation results were expressed in Table 1 with the value of Comparative Example 1 expressed as an index of 100 using reciprocals of measurement values. Larger index values indicate lower rolling resistance and superior low rolling resistance.

TABLE 1

| | | Comparative | Comparative | Comparative | Comparative |
|---|---|---|---|---|---|
| | | Example 1 | Example 2 | Example 3 | Example 4 |
| Blend of | NR parts by mass | 40 | 75 | 75 | 75 |
| coating | SBR parts by mass | 60 | 25 | 25 | 25 |
| rubber | CB1 parts by mass | | 50 | | |
| | CB2 parts by mass | 35 | | 35 | 35 |
| | Aroma oil parts | 5 | 5 | 15 | 5 |
| | by mass | | | | |
| | Zinc oxide parts | 3 | 3 | 3 | 3 |
| | by mass | | | | |
| | Stearic acid parts | 1 | 1 | 1 | 1 |
| | by mass | | | | |
| | Sulfur parts | 3 | 3 | 3 | 5 |
| | by mass | | | | |
| | Vulcanization | 1 | 1 | 1 | 2 |
| | accelerator parts | | | | |
| | by mass | | | | |
| Physical | TB²/M100 | 35.0 | 45.0 | 65.0 | 40.0 |
| properties | | | | | |
| of coating | | | | | |
| rubber | | | | | |
| Cords | Type of organic fiber | PET | PET | PET | PET |
| | Product A dtex/50 mm | 2.0 × 10⁵ | 2.0 × 10⁵ | 2.0 × 10⁵ | 2.0 × 10⁵ |
| Evaluation | Hardness index value | 100 | 85 | 85 | 110 |
| of coating | tan δ (60° C.) | 100 | 115 | 95 | 110 |
| rubber | index value | | | | |
| Tire | High-speed steering | 100 | 90 | 90 | 110 |
| evaluation | stability index value | | | | |
| | High-speed durability | 100 | 105 | 115 | 80 |
| | index value | | | | |
| | Rolling resistance | 100 | 110 | 90 | 105 |
| | index value | | | | |

| | | Example 1 | Example 2 | Example 3 | Example 4 |
|---|---|---|---|---|---|
| Blend of | NR parts by mass | 75 | 75 | 75 | 100 |
| coating | SBR parts by mass | 25 | 25 | 25 | 0 |
| rubber | CB1 parts by mass | | | | |
| | CB2 parts by mass | 35 | 30 | 60 | 35 |
| | Aroma oil parts | 5 | 5 | 5 | 5 |
| | by mass | | | | |
| | Zinc oxide parts | 3 | 3 | 3 | 3 |
| | by mass | | | | |
| | Stearic acid parts | 1 | 1 | 1 | 1 |
| | by mass | | | | |
| | Sulfur parts | 3 | 3 | 3 | 3 |
| | by mass | | | | |
| | Vulcanization | 1 | 1 | 1 | 1 |
| | accelerator parts | | | | |
| | by mass | | | | |
| Physical | TB²/M100 | 70.0 | 70.0 | 60.0 | 85.0 |
| properties | | | | | |
| of coating | | | | | |
| rubber | | | | | |
| Cords | Type of organic fiber | PET | PET | PET | PET |
| | Product A dtex/50 mm | 2.0 × 10⁵ | 2.0 × 10⁵ | 2.0 × 10⁵ | 2.0 × 10⁵ |
| Evaluation | Hardness index value | 110 | 105 | 110 | 110 |
| of coating | tan δ (60° C.) | 105 | 110 | 100 | 110 |
| rubber | index value | | | | |
| Tire | High-speed steering | 105 | 105 | 110 | 105 |
| evaluation | stability index value | | | | |
| | High-speed durability | 110 | 115 | 105 | 120 |
| | index value | | | | |
| | Rolling resistance | 105 | 105 | 100 | 105 |
| | index value | | | | |
| | | Example 5 | Example 6 | Example 7 | Example 8 |
| Blend of | NR parts by mass | 75 | 75 | 75 | 75 |
| coating | SBR parts by mass | 25 | 25 | 25 | 25 |
| rubber | CB1 parts by mass | | | | |
| | CB2 parts by mass | 35 | 35 | 35 | 35 |
| | Aroma oil parts | 0 | 10 | 5 | 5 |
| | by mass | | | | |
| | Zinc oxide parts | 3 | 3 | 3 | 3 |
| | by mass | | | | |
| | Stearic acid parts | 1 | 1 | 1 | 1 |
| | by mass | | | | |
| | Sulfur parts | 3 | 3 | 3 | 3 |
| | by mass | | | | |
| | Vulcanization | 1 | 1 | 1 | 1 |
| | accelerator parts | | | | |
| | by mass | | | | |
| Physical | TB²/M100 | 60.0 | 75.0 | 70.0 | 70.0 |
| properties | | | | | |
| of coating | | | | | |
| rubber | | | | | |
| Cords | Type of organic fiber | PET | PET | PET | PET |
| | Product A dtex/50 mm | 2.0 × 10⁵ | 2.0 × 10⁵ | 3.0 × 10⁵ | 1.0 × 10⁵ |
| Evaluation | Hardness index value | 115 | 105 | 110 | 110 |
| of coating | tan δ (60° C.) | 110 | 100 | 105 | 105 |
| rubber | index value | | | | |
| Tire | High-speed steering | 110 | 105 | 110 | 100 |
| evaluation | stability index value | | | | |
| | High-speed durability | 110 | 110 | 105 | 115 |
| | index value | | | | |
| | Rolling resistance | 105 | 100 | 100 | 105 |
| | index value | | | | |

Types of raw materials used as indicated in Table 1 are described below.
NR: Natural rubber, SIR20, available from PT. NUSIRA
SBR: Styrene-butadiene rubber, Nipol 1502, available from Zeon Corporation
CB 1: Carbon black, Niteron #GN, available from NIPPON STEEL Carbon Co., Ltd. (nitrogen adsorption specific surface area N₂SA: 30 m²/g)
CB 2: Carbon black, Niteron #300 IH, available from NIPPON STEEL Carbon Co., Ltd. (nitrogen adsorption specific surface area N₂SA: 120 m²/g)
Aroma Oil (Diana Process NH-60, available from Idemitsu Kosan, Co., Ltd.)
Zinc oxide: Zinc Oxide III, available from Seido Chemical Industry Co., Ltd.
Stearic acid: stearic acid YR, available from NOF CORPORATION
Sulfur: Oil treated sulfur, available from Hosoi Chemical Industry Co., Ltd.
Vulcanization accelerator: Santocure CBS, available from FLEXSYS

As can be seen from Table 1, the tires of Examples 1 to 8 improve in high-speed steering stability, high-speed durability, and low rolling resistance in contrast to Comparative Example 1, and these performances are provided in a well-balanced and compatible manner. Furthermore, the physical properties of the coating rubber itself are improved in hardness and tan δ (60° C.) in contrast to Comparative Example 1. On the other hand, in Comparative Example 2, the nitrogen adsorption specific surface area N₂SA of carbon black is small, and thus hardness of the coating rubber is not sufficiently obtained, and high-speed steering stability is decreased. In Comparative Example 3, the blended amount of the aroma oil is large, and thus hardness and tan δ (60° C.) of the coating rubber are not sufficiently obtained, and high-speed steering stability and low rolling resistance are decreased. In Comparative Example 4, compound of coating rubber is suitable, but TB²/M100 is small, and thus high-speed durability is decreased.

1. A pneumatic tire, comprising:
a tread portion extending in a tire circumferential direction and having an annular shape;
a pair of sidewall portions respectively disposed on both sides of the tread portion;
a pair of bead portions each disposed on an inner side of the pair of sidewall portions in a tire radial direction; and
a reinforcing layer including a cord embedded in at least one portion selected from the tread portion, the sidewall portions, and the bead portions;
a coating rubber covering the cord included in the reinforcing layer being made of a rubber composition in which 30 parts by mass to 60 parts by mass of carbon black having a nitrogen adsorption specific surface area N₂SA of 100 m²/g or more is blended and 0 parts by mass or more and 10 parts by mass or less of aroma oil is optionally blended, per 100 parts by mass of a rubber component containing 70 mass % to 100 mass % of a natural rubber and in which a strength at break TB (unit: MPa) at 100° C. and a stress M100 (unit: MPa) at 100% elongation at 100° C. satisfy a relationship TB²/M100≥50.0.

2. The pneumatic tire according to claim 1, wherein the cord is made of an organic fiber.

3. The pneumatic tire according to claim 2, wherein a product A=D×E of a regular fineness D per cord (unit: dtex/cord) and a cord count E per 50 mm (unit: cord count/50 mm) of the cord in a direction orthogonal to an extension direction of the cord ranges from 1.0×10⁵ dtex/50 mm to 3.0×10⁵ dtex/50 mm.

4. The pneumatic tire according to claim 2, wherein the cord has an elongation under a 1.5 cN/dtex load of from 5.0% to 8.0% and an elongation at break of 20% or more.

5. The pneumatic tire according to claim 1, wherein the reinforcing layer is a carcass layer.

6. The pneumatic tire according to claim 3, wherein the cord has an elongation under a 1.5 cN/dtex load of from 5.0% to 8.0% and an elongation at break of 20% or more.

7. The pneumatic tire according to claim 6, wherein the reinforcing layer is a carcass layer.
